(19) United States
(12) Patent Application Publication
(10) Pub. No.: US 2012/0157600 A1
(43) Pub. Date: Jun. 21, 2012

(54) MOLDED THERMOPLASTIC ARTICLES COMPRISING THERMALLY CONDUCTIVE POLYMERS

(75) Inventor: Yuji Saga, Utsunomiya-Shi (JP)

(73) Assignee: E.I.DU PONT DE NEMOURS AND COMPANY, Wilmington, DE (US)

(21) Appl. No.: 13/316,622

(22) Filed: Dec. 12, 2011

Related U.S. Application Data
(60) Provisional application No. 61/424,796, filed on Dec. 20, 2010.

(51) Int. Cl. C08K 3/04; C08L 77/00

(52) U.S. Cl. 524/496; 524/606

(57) ABSTRACT

Disclosed are molded thermally conductive thermoplastic articles having low light reflectance, comprising thermoplastic polymers blended with thermally conductive fillers and carbon black powders. The polymer blends are characterized by a unique combination of high thermal conductiveness and low light reflectance. The molded articles in which such properties are desirable include, without limitation, a chassis structure for electrical and electronic devices wherein a light source is constructed inside and wherein heat is generated in the light source so as to be dissipated to an ambient atmosphere.

### CROSS REFERENCE TO RELATED APPLICATIONS

This application claims the benefit of priority to U.S. Provisional Application No. 61/424,796, filed Dec. 20, 2010.

### FIELD OF THE INVENTION

The present invention relates to molded thermally conductive thermoplastic articles having low light reflectance, comprising thermoplastic polymers blended with thermally conductive fillers and carbon black powers. The polymer blends are characterized by a unique combination of high thermal conduciveness and low light reflectance. More particularly the present invention relates to molded articles having such properties including without limitation, a chassis structure for electrical and electronic devices wherein a light source is constructed inside and wherein heat is generated in the light source so as to be dissipated to an ambient atmosphere.

### BACKGROUND OF THE INVENTION

Many electrical and electronic devices include a light emitting package in a structure such as a mold frame, a chassis structure or a metal bottom cover. These can be used as a light source for a backlight unit of an LCD or as a light unit in an illumination field backlight unit. In general, there are edge-type backlight units and direct-type backlight units, depending on the position of a light source. Because of their excellent mechanical properties, thermoplastic polymeric resin compositions are used to manufacture articles of various sizes and shapes, including without limitation chassis components, and housings. In many cases, because of the design flexibility and their low cost, polymer resin compositions have replaced metal in these applications. However, many of these applications require that the parts be in the vicinity of or in contact with heat sources such as electrical lights. It is therefore desirable to form these parts from materials that are sufficiently thermally conductive to dissipate the heat generated. There is a need for thermally conductive material having low light reflectance in a backlight frame or chassis of LCD to control directional characteristics of light, in particular in 3D LCD. Thus, thermally conductive resin compositions having low light reflectance would be desirable for a backlight frame or chassis of that kind of LCD. In an attempt to improve thermal conductive characteristics, it has been the conventional practice to add thermally conductive materials to thermoplastic compositions. U.S. Pat. No. 6,487,073 describes a case for dissipating heat from an electronic device, comprising a housing of a net-shaped moldable thermally conductive composite material of a polymer base matrix with thermally conductive filler, and in thermal communication with an electronic component with heat dissipating from a heat generating electronic component and therethrough. No examples of resin compositions having low light reflectance are disclosed.

Other desirable properties for LCD structural components include low light reflectance. For example, U.S. Pat. No. 7,235,918 describes a molded reflector article coated with a light-reflecting metal and a resin composition for the article comprising a base polymer matrix and a thermally-conductive carbon material. However, no examples having high thermal conductivity and low reflectance are disclosed.

Although certain conventional materials including the construction of certain articles, as described above, have proven suitable for use in LCD structural components, it would be useful to develop a material having a combination of high thermal conductivity and low light reflectance than conventional materials. Such a material would provide improved thermal conduciveness and desirable low light reflectance for LCD structural components and other applications.

### SUMMARY OF THE INVENTION

There is disclosed and claimed herein a molded thermoplastic article comprising (a) about 19.5 to about 79.5 weight percent of one or more thermoplastic polymers; (b) about 20 to about 80 weight percent of a filler of which thermal conductivity is at least 5 W/mK; (c) about 0.5 to 10 weight percent of carbon black powder; and (d) 0 to about 30 weight percent of at least on fibrous filler having a thermal conductivity of no more than 5 W/mK; wherein molded articles prepared from said thermoplastic composition, have a light reflectance of no more than 10 percent at wavelengths of 400 nm and 700 nm, as measured using a spectrophotometer, and have a thermal conductivity of at least 1 W/mK as measured with the laser flash method according to ASTM E1462.

The molded articles of the invention are especially useful in applications in electronic and electrical apparatus including a chassis structure for electrical and electronic devices wherein a light source is constructed inside and wherein heat is generated in the light source so as to be dissipated to an ambient atmosphere, and having improved thermal conductivity properties, made from thermally conductive thermoplastic resin compositions. Preferred applications involve the light emitting package used as a light source for a backlight unit of an LCD or as a light unit in an illumination field backlight unit. Other aspects and embodiments of this invention will be better understood in view of the following detailed description of preferred embodiments.

### DETAILED DESCRIPTION OF THE INVENTION

### The Thermoplastic Polymer (a)

The thermoplastic polymer is the polymer matrix of the composition, and in which one or more polymers are used in a continuous phase. Useful thermoplastic polymers include thermoplastic polyesters, polyamides, polycarbonates, polyphenylene oxides, polyarylene sulfides, liquid crystal polymers and syndiotactic polystyrenes, and blends thereof. Preferred thermoplastic polymers are polyesters, polyamides, liquid crystal polymers, and polyarylene sulfide because of their higher stiffness, better moldability, and flame retardancy that are important requirements of frame materials in this application.

More preferred thermoplastic polyesters of this invention include polyesters having an inherent viscosity of 0.3 or greater and that are, in general, linear saturated condensation products of diols and dicarboxylic acids, or reactive derivatives thereof. Preferably, they will comprise condensation products of aromatic dicarboxylic acids having 8 to 14 carbon atoms and at least one diol selected from the group consisting of neopentyl glycol, cyclohexanedimethanol, 2,2-dimethyl-1,3-propane diol and aliphatic glycols of the formula HO(CH₂)ₙOH where n is an integer of 2 to 10. Up to 20 mole percent of the diol may be an aromatic diol such as ethoxylated bisphenol A, sold under the tradename Dianol® 220 by Akzo Nobel Chemicals, Inc.; hydroquinone; biphenol; or bisphenol A. Up to 50 mole percent of the aromatic dicarboxylic acids can be replaced by at least one different aromatic dicarboxylic acid having from 8 to 14 carbon atoms, and/or up to 20 mole percent can be replaced by an aliphatic dicarboxylic acid having from 2 to 12 carbon atoms. Copolymers may be prepared from two or more diols or reactive equivalents thereof and at least one dicarboxylic acid or reactive equivalent thereof or two or more dicarboxylic acids or reactive equivalents thereof and at least one diol or reactive equivalent thereof. Difunctional hydroxy acid monomers such as hydroxybenzoic acid or hydroxynaphthoic acid or their reactive equivalents may also be used as comonomers.

Preferred polyesters include poly(ethylene terephthalate) (PET), poly(1,4-butylene terephthalate) (PBT), poly(1,3-propylene terephthalate) (PPT), poly(1,4-butylene 2,6-naphthalate) (PBN), poly(ethylene 2,6-naphthalate) (PEN), poly(1,4-cyclohexylene dimethylene terephthalate) (PCT), and copolymers and mixtures of the foregoing. Also preferred are 1,4-cyclohexylene dimethylene terephthalate/isophthalate copolymer and other linear homopolymer esters derived from aromatic dicarboxylic acids, including isophthalic acid; bibenzoic acid; naphthalenedicarboxylic acids including the 1,5-; 2,6-; and 2,7-naphthalenedicarboxylic acids; 4,4′-diphenylenedicarboxylic acid; bis(p-carboxyphenyl)methane; ethylene-bis-p-benzoic acid; 1,4-tetramethylene bis(p-oxybenzoic) acid; ethylene bis(p-oxybenzoic) acid; 1,3-trimethylene bis(p-oxybenzoic) acid; and 1,4-tetramethylene bis(p-oxybenzoic) acid, and glycols selected from the group consisting of 2,2-dimethyl-1,3-propane diol; neopentyl glycol; cyclohexane dimethanol; and aliphatic glycols of the general formula HO(CH₂)ₙOH where n is an integer from 2 to 10, e.g., ethylene glycol; 1,3-trimethylene glycol; 1,4-tetramethylene glycol; -1,6-hexamethylene glycol; 1,8-octamethylene glycol; 1,10-decamethylene glycol; 1,3-propylene glycol; and 1,4-butylene glycol. Up to 20 mole percent, as indicated above, of one or more aliphatic acids, including adipic, sebacic, azelaic, dodecanedioic acid or 1,4-cyclohexanedicarboxylic acid can be present. Also preferred are copolymers derived from 1,4-butanediol, ethoxylated bisphenol A, and terephthalic acid or reactive equivalents thereof. Also preferred are random copolymers of at least two of PET, PBT, and PPT, and mixtures of at least two of PET, PBT, and PPT, and mixtures of any of the forgoing.

The thermoplastic polyester may also be in the form of copolymers that contain poly(alkylene oxide) soft segments (blocks). The poly(alkylene oxide) segments are present in about 1 to about 15 parts by weight per 100 parts per weight of thermoplastic polyester. The poly(alkylene oxide) segments have a number average molecular weight in the range of about 200 to about 3,250 or, preferably, in the range of about 600 to about 1,500. Preferred copolymers contain poly(ethylene oxide) and/or poly(tetramethylenether glycol) incorporated into a PET or PBT chain. Methods of incorporation are known to those skilled in the art and can include using the poly(alkylene oxide) soft segment as a comonomer during the polymerization reaction to form the polyester. PET may be blended with copolymers of PBT and at least one poly(alkylene oxide). A poly(alkylene oxide) may also be blended with a PET/PBT copolymer. The inclusion of a poly(alkylene oxide) soft segment into the polyester portion of the composition may accelerate the rate of crystallization of the polyester.

Preferred polyamides include semi-crystalline polyamide and amorphous polyamide.

The semi-crystalline polyamide includes aliphatic or semi-aromatic semi-crystalline polyamides.

The semi-crystalline aliphatic polyamide may be derived from aliphatic and/or alicyclic monomers such as one or more of adipic acid, sebacic acid, azelaic acid, dodecanedoic acid, or their derivatives and the like, aliphatic C₆-C₂₀ alkylenediamines, alicyclic diamines, lactams, and amino acids. Preferred diamines include bis(p-aminocyclohexyl)methane; hexamethylenediamine; 2-methylpentamethylenediamine; 2-methyloctamethylenediamine; trimethylhexamethylenediamine; 1,8-diaminooctane; 1,9-diaminononane; 1,10-diaminodecane; 1,12-diaminododecane; and m-xylylenediamine. Preferred lactams or amino acids include 11-aminododecanoic acid, caprolactam, and laurolactam.

Preferred aliphatic polyamides include polyamide 6; polyamide 6,6; polyamide 4,6; polyamide 6,10; polyamide 6,12; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14; polyamide 6,14; polyamide 6,13; polyamide 6,15; polyamide 6,16; and polyamide 6,13.

The semi-aromatic semi-crystalline polyamides are one or more homopolymers, copolymers, terpolymers, or higher polymers that are derived from monomers containing aromatic groups. Examples of monomers containing aromatic groups are terephthalic acid and its derivatives. It is preferred that about 5 to about 75 mole percent of the monomers used to make the aromatic polyamide used in the present invention contain aromatic groups, and it is still more preferred that about 10 to about 55 mole percent of the monomers contain aromatic groups.

Examples of preferred semi-crystalline semi-aromatic polyamides include poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T); hexamethylene adipamide/hexamethylene terephthalamide/hexamethylene isophthalamide copolyamide (polyamide 6,6/6,T/6,I); poly(caprolactam-hexamethylene terephthalamide) (polyamide 6/6,T); and the like.

Preferred semi-crystalline semi-aromatic polyamides are selected from the group consisting of include hexamethylene terephthalamide/2-methylpentamethylene terephthalamide copolyamide (polyamide 6,T/D,T), and preferably having 45-55 mol % repeat units 6,T and 55-45 mol % repeat units D,T.

In the present invention, a semi-crystalline semi-aromatic polyamide is preferred in terms of heat resistance, dimension stability and moisture resistance at high temperature

Semi-crystalline semi-aromatic polyamides derived from monomers containing aromatic groups are especially advantageous for uses in applications that require a balance of properties (e.g., mechanical performance, moisture resistance, heat resistance, etc.) in the polyamide composition as well as higher thermal conductivity.

In the present invention, amorphous polyamides can be used in the polymer composition without giving significant negative influence on the properties. They are one or more homopolymers, copolymers, terpolymers, or higher polymers that are derived from monomers containing isophthalic acid and/or dimethyldiaminodicyclohexylmethane groups.

In the preferred amorphous polyamide, the polyamide consists of a polymer or copolymer having repeating units derived from a carboxylic acid component and an aliphatic diamine component. The carboxylic acid component is isophthalic acid or a mixture of isophthalic acid and one or more other carboxylic acids wherein the carboxylic acid component contains at least 55 mole percent, based on the carboxylic acid component, of isophthalic acid. Other carboxylic acids that may be used in the carboxylic acid component include terephthalic acid and adipic acid. The aliphatic diamine component is hexamethylene diamine or a mixture of hexamethylene diamine and 2-methyl pentamethylene diamine and/or 2-ethyltetramethylene diamine, in which the aliphatic diamine component contains at least 40 mole percent, based on the aliphatic diamine component, of hexamethylene diamine.

Examples of preferred amorphous polyamides include poly(hexamethylene terephthalamide/hexamethylene isophthalamide) (polyamide 6,T/6,I), poly(hexamethylene isophthalamide) (polyamide 6,I), poly(metaxylylene isophthalamide/hexamethylene isophthalamide) (polyamide MXD,I/6,I), poly(metaxylylene isophthalamide/metaxylylene terephthalamide/hexamethylene isophthalamide) (polyamide MXD,I/MXD,T/6,I/6,T), poly(metaxylylene isophthalamide/dodecamethylene isophthalamide) (polyamide MXD,I/12,I), poly(metaxylylene isophthalamide) (polyamide MXD,I), poly(dimethyldiaminodicyclohexylmethane isophthalamide/dodecanamide) (polyamide MACM,I/12), poly(dimethyldiaminodicyclohexylmethane isophthalamide/dimethyldiaminodicyclohexylmethane terephthalamide/dodecanamide) (polyamide MACM,I/MACM,T/12), poly(hexamethylene isophthalamide/dimethyldiaminodicyclohexylmethane isophthalamide/dodecanamide) (polyamide 6,I/MACM,I/12), poly(hexamethylene isophthalamide/hexamethylene terephthalamide/dimethyldiaminodicyclohexylmethane isophthalamid/dimethyldiaminodicyclohexylmethane terephthalamide) (polyamide 6,I/6,T/MACM,I/MACM,T), poly(hexamethylene isophthalamide/hexamethylene terephthalamide/dimethyldiaminodicyclohexylmethane isophthalamid/dimethyldiaminodicyclohexylmethane terephthalamide/dodecanamide) (polyamide 6,I/6,T/MACM,I/MACM,T/12), poly(dimethyldiaminodicyclohexylmethane isophthalamide/dimethyldiaminodicyclohexylmethane dodecanamide) (polyamide MACM,I/MACM,12) and mixtures thereof.

When an amorphous polyamide is used, the semicrystalline polyamide is present in about 40 to about 100 (and preferably about 70 to about 100) weight percent, based on the total amount of semicrystalline and amorphous polyamide present.

The polyarylene sulfide may be a straight-chain compound, a compound having been subjected to treatment at high temperature in the presence of oxygen to crosslink, a compound having some amount of a crosslinked or branched structure introduced therein by adding a small amount of a trihalo or more polyhalo compound, a compound having been subjected to heat treatment in a non-oxidizing inert gas such as nitrogen, or a mixture of those structures.

By a LCP is meant a polymer that is anisotropic when tested using the TOT test or any reasonable variation thereof, as described in U.S. Pat. No. 4,118,372, which is hereby incorporated by reference. Useful LCPs include polyesters, poly(ester-amides), and poly(ester-imides). One preferred form of LCP is “all aromatic”, that is all of the groups in the polymer main chain are aromatic (except for the linking groups such as ester groups), but side groups which are not aromatic may be present.

In a preferred embodiment, the thermoplastic polymer is included in an amount of from about 19.7 to about 79.7 wt %, based on the total weight of the composition. Preferably, the thermoplastic polymer is included in an amount of from about 35 wt % to about 65 wt %.

### The Thermally Conductive Filler (b)

The thermal conductive filler useful in the invention is not particularly limited so long as the thermal conductivity of filler is at least 5 W/mK and preferably at least 10 W/mK, and more preferably 100 W/mK. Useful thermally conductive fillers are selected from the group consisting of oxide powders, flakes and fibers composed of aluminum oxide (alumina), zinc oxide, magnesium oxide and silicon dioxide; nitride powders, flakes and fibers composed of boron nitride, aluminum nitride and silicon nitride; metal and metal alloy powders, flakes and fibers composed of gold, silver, aluminum, iron, copper, tin, tin base alloy used as lead-free solder; carbon fiber, graphite; silicon carbide powder; zinc sulfide, magnesium carbonate and calcium fluoride powder; and the like. For purposes of this description “composed of” generally has the same meaning as “comprising”. These fillers may be used independently, or a combination of two or more of them may be used. Preferred thermally conducting fillers are selected from the group consisting of magnesium oxide, graphite, carbon fibers, calcium fluoride powder, magnesium carbonate, boehmite; and especially preferred thermally conducting fillers is graphite.

When graphite is used as component (b), the graphite may be synthetically produced or naturally produced as far as it has flake shape.

There are three types of naturally produced graphite that are commercially available. They are flake graphite, amorphous graphite and crystal vein graphite as naturally produced graphite.

Flake graphite, as indicated by the name, has a flaky morphology. Amorphous graphite is not truly amorphous as its name suggests but is actually crystalline. Crystal vein graphite generally has a vein like appearance on its outer surface from which it derives its name.

Synthetic graphite can be produced from coke and/or pitch that are derived from petroleum or coal. Synthetic graphite is of higher purity than natural graphite, but not as crystalline.

Flake graphite and crystal vein graphite that are naturally produced are preferred in terms of thermal conductivity and dimension stability, and flake graphite is more preferred.

Thermally conductive fillers (b) can have a broad particle size distribution. If the particle diameter of the filler is too small, the viscosity of the resin may increase during blending to the extent that complete dispersion of the filler can not be accomplished. As a result, it may not be possible to obtain resin having high thermal conductivity. If the particle diameter of the filler is too large, it may become impossible to inject the thermally conductive resin into thin portions of the resin injection cavity, especially those associated with heat radiating members. Preferably, the maximum average particle size is less than 300 microns, and more preferably, less than 200 microns; as measured using an AccuSizer Model 780A (Particle Sizing Systems, Santa Barbara, Calif.) by using laser-diffraction type particle diameter distribution with a Selas Granulometer “model 920” or a laser-diffraction scattering method particle diameter distribution measuring device “LS-230” produced by Coulter K.K., for instance. Preferably, the average particle size is between 1 micron to 100 microns, and more preferably, between 5 microns to 80 microns. The particles or granules which have multi-modal size distribution in their particle size can also be used. Especially preferred thermally conductive fillers are graphite flakes having a particle size of from about 5 to about 100 microns and preferably about 20 to about 80 microns.

The surface of the thermally conductive filler, or a fibrous filer having a thermal conductivity less than 5 W/mK (as disclosed below), can be processed with a coupling agent, for the purpose of improving the interfacial bonding between the filler surface and the matrix resin. Examples of the coupling agent include silane series, titanate series, zirconate series, aluminate series, and zircoaluminate series coupling agents. Useful coupling agents include metal hydroxides and alkoxides including those of Group IIIa thru VIIIa, Ib, IIb, IIIb, and IVb of the Periodic Table and the lanthanides. Specific coupling agents are metal hydroxides and alkoxides of metals selected from the group consisting of Ti, Zr, Mn, Fe, Co, Ni, Cu, Zn, Al, and B. Preferred metal hydroxides and alkoxides are those of Ti and Zr. Specific metal alkoxide coupling agents are titanate and zirconate orthoesters and chelates including compounds of the formula (I), (II) and (III):

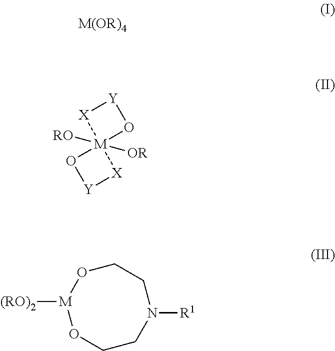

wherein

### M is Ti or Zr;

R is a monovalent C₁-C₈ linear or branched alkyl;
Y is a divalent radical selected from —CH(CH₃)—, —C(CH₃)═CH₂—, or —CH₂CH₂—;
X is selected from OH, —N(R¹)₂, —C(O)OR³, —C(O)R³, —CO₂⁻A⁺; wherein
R¹ is a —CH₃ or C₂-C₄ linear or branched alkyl, optionally substituted with a hydroxyl or interrupted with an ether oxygen; provided that no more than one heteroatom is bonded to any one carbon atom;
R³ is C₁-C₄ linear or branched alkyl;
A⁺ is selected from NH₄⁺, Li⁺, Na⁺, or K⁺.

The coupling agent can be added to the filler before mixing the filler with the resin, or can be added while blending the filler with the resin. The additive amount of coupling agent is preferably 0.1 through 5 wt % or preferably 0.5 through 2 wt % with respect to the weight of the filler. Addition of coupling agent during the blending of filler with the resin has the added advantage of improving the adhesiveness between the metal used in the joint surface between the heat transfer unit or heat radiating unit and the thermally conductive resin.

The content of the thermally conductive filler in the thermoplastic composition is in a range of 20 to 80 wt %, and preferably 30 to 70 wt and more preferably 40 to 60 wt %, where the weight percentages are based on the total weight of the thermoplastic composition.

### The Carbon Black Powder (c)

In the present invention, carbon black powder (c) is, for example, furnace black, channel black or acetylene black, preferably one having an average particle size of less than 100 nm, and more preferably one having an average particle size of less than 20 nm. In the present invention, blackish pigments other than carbon black such as black chromium oxide, titanium black, black iron oxide, black organic pigments such as aniline black and mixed organic pigments obtained by mixing at least two organic pigments selected from red, blue, green, violet, yellow, cyan and magenta pigments so as to exhibit an artificial black color may be used.

The content of the carbon black powder (c) in the thermoplastic composition is in a range of 0.5 to 10 wt %, and preferably 0.6 to 3 wt %, and more preferably 0.8 to 2 wt %, where the weight percentages are based on the total weight of the thermoplastic composition.

### The Fibrous Filler (d)

The fibrous filler having a thermal conductivity of no more than 5 W/mK used as component (d) in the present invention is a needle-like fibrous material. Examples of preferred fibrous fillers include wollastonite (calcium silicate whiskers), glass fibers, aluminum borate fibers, calcium carbonate fibers, and potassium titanate fibers. Preferable fibrous filler is glass fiber.

The fibrous filler will preferably have a weight average aspect ratio of at least 5, or more preferably of at least 10. When used, the optional fibrous filler will preferably be present in about 5 to about 30 weight percent, or more preferably in about 10 to about 20 weight percent, based on the total weight of the composition. Fibrous filler can improve mechanical strength and thermal conductivity in in-plane of mold parts that are important properties required of frame material.

Polymeric toughening agent can be optionally used as component (e) in the present invention is any toughening agent that is effective for the thermoplastic polymer used.

When the thermoplastic polymer is a polyester, the toughening agent will typically be an elastomer or has a relatively low melting point, generally <200° C., preferably 150° C. and that has attached to it functional groups that can react with the thermoplastic polyester (and optionally other polymers present). Since thermoplastic polyesters usually have carboxyl and hydroxyl groups present, these functional groups usually can react with carboxyl and/or hydroxyl groups. Examples of such functional groups include epoxy, carboxylic anhydride, hydroxyl (alcohol), carboxyl, and isocyanate. Preferred functional groups are epoxy, and carboxylic anhydride, and epoxy is especially preferred. Such functional groups are usually “attached” to the polymeric toughening agent by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber using free radical grafting techniques. The resulting grafted polymer has carboxylic anhydride and/or carboxyl groups attached to it. An example of a polymeric toughening agent wherein the functional groups are copolymerized into the polymer is a copolymer of ethylene and a (meth)acrylate monomer containing the appropriate functional group. By (meth)acrylate herein is meant the compound may be either an acrylate, a methacrylate, or a mixture of the two. Useful (meth)acrylate functional compounds include (meth) acrylic acid, 2-hydroxyethyl (meth)acrylate, glycidyl(meth)acrylate, and 2-isocyanatoethyl(meth)acrylate. In addition to ethylene and a functional (meth)acrylate monomer, other monomers may be copolymerized into such a polymer, such as vinyl acetate, unfunctionalized (meth) acrylate esters such as ethyl(meth)acrylate, n-butyl(meth)acrylate, and cyclohexyl (meth)acrylate. Preferred toughening agents include those listed in U.S. Pat. No. 4,753,980. Especially preferred toughening agents are copolymers of ethylene, ethyl acrylate or n-butyl acrylate, and glycidyl methacrylate.

It is preferred that the polymeric toughening agent used with thermoplastic polyesters contain about 0.5 to about 20 weight percent of monomers containing functional groups, preferably about 1.0 to about 15 weight percent, more preferably about 7 to about 13 weight percent of monomers containing functional groups. There may be more than one type of functional monomer present in the polymeric toughening agent. It has been found that toughness of the composition is increased by increasing the amount of polymeric toughening agent and/or the amount of functional groups. However, these amounts should preferably not be increased to the point that the composition may crosslink, especially before the final part shape is attained.

The polymeric toughening agent used with thermoplastic polyesters may also be thermoplastic acrylic polymers that are not copolymers of ethylene. The thermoplastic acrylic polymers are made by polymerizing acrylic acid, acrylate esters (such as methyl acrylate, n-propyl acrylate, isopropyl acrylate, n-butyl acrylate, n-hexyl acrylate, and n-octyl acrylate), methacrylic acid, and methacrylate esters (such as methyl methacrylate, n-propyl methacrylate, isopropyl methacrylate, n-butyl methacrylate (BA), isobutyl methacrylate, n-amyl methacrylate, n-octyl methacrylate, glycidyl methacrylate (GMA) and the like). Copolymers derived from two or more of the forgoing types of monomers may also be used, as well as copolymers made by polymerizing one or more of the forgoing types of monomers with styrene, acryonitrile, butadiene, isoprene, and the like. Part or all of the components in these copolymers should preferably have a glass transition temperature of not higher than 0° C. Preferred monomers for the preparation of a thermoplastic acrylic polymer toughening agent are methyl acrylate, n-propyl acrylate, isopropyl acrylate, n-butyl acrylate, n-hexyl acrylate, and n-octyl acrylate.

It is preferred that a thermoplastic acrylic polymer toughening agent have a core-shell structure. The core-shell structure is one in which the core portion preferably has a glass transition temperature of 0° C. or Less, while the shell portion is preferably has a glass transition temperature higher than that of the core portion.

The core portion may be grafted with silicone. The shell section may be grafted with a low surface energy substrate such as silicone, fluorine, and the like. An acrylic polymer with a core-shell structure that has low surface energy substrates grafted to the surface will aggregate with itself during or after mixing with the thermoplastic polyester and other components of the composition of the invention and can be easily uniformly dispersed in the composition.

Suitable toughening agents for polyamides are described in U.S. Pat. No. 4,174,358. Preferred toughening agents include polyolefins modified with a compatibilizing agent such as an acid anhydride, dicarboxylic acid or derivative thereof, carboxylic acid or derivative thereof, and/or an epoxy group. The compatibilizing agent may be introduced by grafting an unsaturated acid anhydride, dicarboxylic acid or derivative thereof, carboxylic acid or derivative thereof, and/or an epoxy group to a polyolefin. The compatibilizing agent may also be introduced while the polyolefin is being made by copolymerizing with monomers containing an unsaturated acid anhydride, dicarboxylic acid or derivative thereof, carboxylic acid or derivative thereof, and/or an epoxy group. The compatibilizing agent preferably contains from 3 to 20 carbon atoms. Examples of typical compounds that may be grafted to (or used as comonomers to make) a polyolefin are acrylic acid, methacrylic acid, maleic acid, fumaric acid, itaconic acid, crotonic acid, citrconic acid, maleic anhydride, itaconic anhydride, crotonic anhydride and citraconic anhydride.

When used, the optional polymeric toughening agent will preferably be present in about 2 to about 15 weight percent, or more preferably in about 5 to about 15 weight percent, based on the total weight of the composition.

The compositions described herein may optionally include one or more plasticizers that are suitable for the thermoplastic polymer used. Examples of suitable plasticizers for thermoplastic polyesters are include poly(ethylene glycol) 400 bis(2-ethyl hexanoate), methoxypoly(ethylene glycol) 550 (2-ethyl hexanoate), and tetra(ethylene glycol)bis (2-ethyl hexanoate), and the like. When used, the plasticizer will preferably be present in about 0.5 to about 5 weight percent, based on the total weight of the composition.

When the thermoplastic polymer used in the composition described herein is a polyester, the composition may also optionally include one or more nucleating agents such as a sodium or potassium salt of a carboxylated organic polymer, the sodium salt of a long chain fatty acid, sodium benzoate, and the like. Part or all of the polyester may be replaced with a polyester having end groups, at least some of which have been neutralized with sodium or potassium. When used, the nucleating agent will preferably be present in about 0.1 to about 4 weight percent, based on the total weight of the composition.

Flame retardancy is an important requirement of the frame material in electric and electronics appliance. So, the composition described herein may also optionally include one or more flame retardants. Examples of suitable flame retardants include, but are not limited to brominated polystyrene, polymers of brominated styrenes, brominated epoxy compounds, brominated polycarbonates, poly(pentabromobenzyl acrylate) and metal phosphinates. When used, the flame retardant will preferably be present in about 3 to about 20 weight percent, based on the total weight of the composition. Compositions comprising flame retardants may further comprise one or more flame retardant synergists such as, but not limited to, sodium antimonate and antimony oxide.

The thermoplastic resin composition described herein may also optionally include, in addition to the above components, additives such as heat stabilizers, antioxidants, dyes, mold release agents, lubricants, UV stabilizers, (paint) adhesion promoters, and the like. When used, the foregoing additives will in combination preferably be present in about 0.1 to about 5 weight percent, based on the total weight of the composition.

The compositions described herein are in the form of a melt-mixed blend, wherein all of the polymeric components are well-dispersed within each other and all of the non-polymeric ingredients are homogeneously dispersed in and bound by the polymer matrix, such that the blend forms a unified whole. The blend may be obtained by combining the component materials using any melt-mixing method. The component materials may be mixed to homogeneity using a melt-mixer such as a single or twin-screw extruder, blender, kneader, Banbury mixer, etc. to give a resin composition. Part of the materials may be mixed in a melt-mixer, and the rest of the materials may then be added and further melt-mixed until homogeneous. The sequence of mixing in the manufacture of the thermally conductive polymer resin composition of this invention may be such that individual components may be melted in one shot, or the filler and/or other components may be fed from a side feeder, and the like, as will be understood by those skilled in the art.

The composition described herein may be formed into articles using methods known to those skilled in the art, such as, for example, injection molding, blow molding, or extrusion. Such articles can include those for use in motor housings, lamp housings, lamp housings in automobiles and other vehicles, and electrical and electronic housings. Examples of lamp housings in automobiles and other vehicles are front and rear lights, including headlights, tail lights, and brake lights, particularly those that use light-emitting diode (LED) lamps. The articles may serve as replacements for articles made from aluminum or other metals in many applications.

### Examples

Compounding and Molding Method: The polymeric compositions shown in Table 1 were prepared by compounding in 32 mm Werner and Pfleiderer twin screw extruder. All ingredients were blended together and added to the rear of the extruder except that graphite was side-fed into down stream barrels. Barrel temperatures were set at about 315° C. resulting in melt temperatures of about 330° C.

The compositions were molded into ISO test specimens on an injection molding machine for the measurement of mechanical properties. For measurements of reflectance and thermal conductivity, they were molded into plates of pieces having dimensions 1 mm×60 mm×60 mm. Melt temperature was about 320° C. and mold temperature was 150° C.

Tensile strength and elongation were measured using the ISO 527-1/2 standard method. Flexural strength and modulus were measured using the ISO 178-1/2 standard method. Notched charpy impact was measured using the ISO 179/1 eA standard method. The above tests were conducted at 23° C. The results are shown in Table 1.

Thermal conductivity was measured in the in-plane direction using a laser flash method as described in ASTM E1461. The results are shown in Table 1.

Reflectance was measured by a spectrophotometer Datacolor 650® manufactured by Datacolor. The instrument is PC driven and is programmed to follow the manufacture's instructions driven to measure the reflectance information. The results are shown in Table 1.

The following terms are used in Table 1:

HTN: Zytel® HTN501, a copolyamide 6,T/D,T manufactured by E.I. du Pont de Nemours and Co., Wilmington, Del.
Graphite refers to graphite flake CB-150 having average particle size of 40 μm, supplied by Nippon Graphite Industries, Ltd.
CB refers to carbon black powder, BLACK PEARLS®900, having average particle size of 15 nm, supplied by Cabot Corporation.
Talc refers to talc LMS-200 having average particle size of 5 μm, supplied from Fuji Talc Industrial Co. Ltd.
2,6-NDA: 2,6-naphthalenedicarboxylic acid, manufactured by BP Amoco Chemical Company.
HS refers to heat stabilizer comprising a copper(I) halide and a potassium halide.
Lubricant refers to Licowax OP, manufactured by Clariant Japan.K.K.

TABLE 1

| | Unit | Example-1 | Comp. Ex-1 | Comp. Ex-2 |
|---|---|---|---|---|
| HTN | Wt. % | 57.5 | 58.5 | 48.5 |
| Graphite | | 40.0 | 40.0 | 50.0 |
| CB | | 1.0 | 0 | 0 |
| 2,6-NDA | | 0.6 | 0.6 | 0.6 |
| Talc | | 0.4 | 0.4 | 0.4 |
| HS | | 0.3 | 0.3 | 0.3 |
| Lubricant | | 0.2 | 0.2 | 0.2 |
| Reflectance at 400 nm | % | 8.3 | 10.5 | 11.4 |
| Reflectance at 700 nm | % | 9.0 | 11.0 | 11.8 |
| Thermal conductivity | W/mK | >3 | >3 | >3 |
| Tensile strength | MPa | 77 | 76 | 73 |
| Tensile elonfation | % | 1.0 | 1.1 | 0.7 |
| Flexural strength | MPa | 99 | 107 | 98 |
| Flexural Modulus | GPa | 11.5 | 12.0 | 14.5 |
| N-Charpy Impact | kJ/m2 | 3.0 | 3.2 | 2.1 |

What is claimed is:

1. A molded thermoplastic article comprising:
(a) about 19.5 to about 79.5 weight percent of one or more thermoplastic polymers
(b) about 20 to about 80 weight percent of a filler of which thermally conductive is at least 5 W/mK.
(c) about 0.5 to about 10 weight percent of carbon black powder; and
(d) about 0 to 30 weight percent of fibrous filler having a thermal conductivity of no more than 5 W/mK
wherein molded articles prepared from said thermoplastic composition, have a light reflectance of no more than 10 percent at wavelengths of 400 nm and 700 nm, as measured using a spectrophotometer, and have a thermal conductivity of at least 1 W/mK as measured with the laser flash method according to ASTM E1461.

2. The molded thermoplastic article of claim 1 wherein said one or more thermally conductive fillers (b) are independently selected from the group consisting of calcium fluoride, magnesium oxide, magnesium carbonate, boehmite, graphite flake and carbon fiber.

3. The molded thermoplastic article of claim 2 wherein said thermally conductive filler (b) is graphite flake having an average particle size of 5 to 100 μm.

4. The molded thermoplastic article of claim 1 wherein said fibrous filler (d) is a glass fiber.

5. The molded thermoplastic article of claim 1 wherein said carbon black powder (c) has an average particle size of less than 100 nm.

6. The molded thermoplastic article of claim 1 wherein said one or more thermoplastic polymers (a) are independently selected from the group consisting of thermoplastic polyesters, polyamides, polycarbonates, polyphenylene oxides, polyarylene sulfides, liquid crystal polymers and syndiotactic polystyrenes.

7. The molded thermoplastic article of claim 6 wherein said one or more thermoplastic polymers (a) comprise a semi-crystalline semi-aromatic polyamide selected from the group consisting of hexamethylene terephthalamide/2-methylpentamethylene terephthalamide copolyamide (polyamide 6,T/D,T).

8. The molded thermoplastic article of claim 1 wherein thermal conductivity of said polymer composition is higher than 3 W/m.

9. The molded thermoplastic composition of claim 1 further comprising (e) about 2 to about 15 weight percent of polymeric toughening agent.

10. The molded thermoplastic article of claim 1, comprising a frame or a chassis of LED backlight frame of LCD.
